(19) United States
(12) Patent Application Publication
(10) Pub. No.: US 2009/0055261 A1
(43) Pub. Date: Feb. 26, 2009

(54) Syndicated marketplace architecture for facilitating in-situ purchases

(75) Inventors: Adam E. C. Yeh, Bellevue, WA (US); Arun Sacheti, Sammamish, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/894,996

(22) Filed: Aug. 22, 2007

(51) Int. Cl. G06Q 30/00

(52) U.S. Cl. 705/14; 705/26

(57) ABSTRACT

A model for implementing a syndicated marketplace service is provided by an architecture that applies a payment instrumentation process to syndicated items, including advertising, classified listings, marketplace catalogs and the like, to expose such items as transaction-able in a virtual marketplace. The syndicated items are presented, as transactional advertisements or listings, through binding to transaction functionalities provided by user interface (“UI”) gadgets. The UI gadgets provide targeted and contextual handling of the instrumented transactional advertisements or listings when implemented at a particular site. The model enables web site publishers to readily syndicate the necessary services to offer products and services that are targeted, for example by location, time, or audience demographic, and which may be closely related to themes, content, and information presented on the publisher's sites. The sales are transacted without requiring end-users to be redirected off the sites to purchase products and services from a centralized marketplace.

### BACKGROUND

The idea of a syndicated marketplace is to enable purchase transactions to happen at the right place, at the right time, and for the right audiences. However, this very idea of bringing merchants and their target audiences together has not yet been realized in today's online e-commerce platform architectures. It is not yet a reality for either an individual with something to sell, or the owners of web sites with the power to aggregate key audiences (specifically, those associated with blogging and social networking sites), to be able to come together and effect transactions in a non-disruptive fashion.

Today, if an individual wants to sell something, it is nearly impossible to make the transaction happen end-to-end in the places where the individual is already connected with his or her audience of choice. In many social networking or blogging environments, for example, individuals cannot typically make transactions happen because the entry barriers are currently too high for setting up a merchant account. As a result, transactions frequently only happen where centralized online marketplace resources are formed such as Windows® Marketplace, eBay®, Amazon.com®, etc.

While such centralized online marketplaces can provide satisfactory experiences in many cases, they potentially suffer from audience saturation as a result of their exclusive, buy and sell focus. The individual sellers, along with everybody else, are competing for the same audience pool—the buyers that come to these sites looking for something. Accordingly, an individual who wishes to sell something must often compete with thousands of others who are selling the same thing at the same time.

In the meantime, the owners of blogging and social networking sites lack a good option for monetizing their assets. These sites are currently under-monetized by their site owners and outside the reach of most existing advertising models. Yet, advertisers and merchants are extremely eager to monetize these sites because they tend to focus discussions on a single or just a few subjects, and also tend to have audiences which are very loyal. In other words, the targeting potential for these sites is often very high. The web site publishers, however, are typically reluctant to open these sites to advertisers and merchants because the existing monetization tools tend to be overly disruptive to the intentions of the individuals that frequent such sites.

The most popular monetization tools currently available to website owners attempt to redirect users to merchant websites by targeting advertising to potential buyers based on the content of the websites that a user visits. If a potential buyer wants to know more about an advertisement or product, they are redirected to the websites of the merchants who want to sell them the products or services. The best known metaphor is a click-able ad, where audiences click away to another site, but at the end of the day a site owner may only be paid a few cents per click-through.

Associate-type programs offer a slightly different, but often equally flawed, business model. Web site publishers hosting a facility to implement an associate-type program typically get paid for each transaction that happens as the result of a referral. Such facilities, however, tend to have very little flexibility in their ability to remain contextually relevant to the site that hosts them, and the interested buyer is again being redirected. As a result, the web site publishers will not have a second chance of selling related goods or services.

Even if site owners do choose to use one of these monetization tools, the individuals visiting their website may be reluctant to interrupt their on-line experience to be redirected to another site to purchase goods or services. This behavior is termed “click through reluctance.” Many users do not like to be forced off to another web site where its only goal is to sell something. The cognitive effect can be troubling or perceived as a hassle. Even though a product may look very appealing, when a spur of the moment purchase becomes an unwanted hassle for a would-be buyer, the transaction may be put off and never completed.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A model for implementing a syndicated marketplace service is provided by an architecture that applies a payment instrumentation process to syndicated items, including advertising, classified listings, marketplace catalogs and the like that are drawn from a variety of different sources, to expose such items as transaction-able in a virtual marketplace. The term “transaction-able” is used to mean that the syndicated item displayed at a given web site is capable of being part of a completed transaction “in-situ” (i.e., in its proper place). When clicked upon, payment for the item may be collected from the buyer in a singular and seamless experience, without requiring redirection off the site to another resource such as a centralized marketplace.

The syndicated items are presented, as transactional advertisements or listings, through binding to transaction functionalities provided by one or more user interface (“UI”) gadgets. While flexibly configurable, the UI gadgets typically provide targeted and contextual handling of the instrumented transactional advertisements or listings when implemented at the particular site. The model thus enables web site publishers to readily syndicate the necessary services to offer products and services that are targeted, for example by location, time, or audience demographic, and which may be closely related to themes, content, and information presented on the publisher's sites. In addition, the sales are transacted without requiring end-users to be redirected off the sites to purchase products/services from a centralized marketplace.

In various illustrative examples, the syndicated marketplaces services support a CPA (“Cost Per Action”) cost model that advertisers use when placing product/service advertisements and/or listings into the virtual marketplace. The CPA cost model holds the assessment of transaction fees until the time the products or services are actually sold to buyers. Sellers may post products and services for distribution through the syndicated marketplace service using one or more UI gadgets that implement the functionality necessary—including shopping cart, payment, and search capabilities, for example—to complete the sale of an item from the instrumented transactional advertisement/listing. These transaction-able items may be implemented anywhere the seller has a virtual presence, such as a blog, a personal or social networking page (e.g., Microsoft Windows Live Spaces) or other web resource or service.

Advantageously, the present syndicated marketplace service model enables virtual marketplace transactions to be supported by both traditional and non-traditional e-commerce platforms so that publishers may monetize their assets without their targeted audience being redirected to other sites. Potential buyers may browse listings from vendors that are broadly distributed across the World Wide Web, elect to purchase items from more than one vendor and, unlike existing systems, pay for those items without ever leaving the web site. In addition, the transactions are implemented while providing a consistent experience for buyers so they do not feel as if they are performing the transaction with an unknown site or entity.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 is a diagram of an illustrative syndicated marketplace services model;

FIG. 2 shows an illustrative tiered functional architecture for syndicated marketplace services;

FIG. 3 shows an illustrative implementation for UI gadgets;

FIG. 4 shows an illustrative payment page UI gadget;

FIG. 5 shows an illustrative catalog UI gadget;

FIG. 6 shows an illustrative implementation for an application tier;

FIG. 7 is a diagram for an illustrative syndication and settlement flow; and,

FIG. 8 shows an illustrative implementation for backend support.

Like reference numerals indicate like elements in the drawings.

### DETAILED DESCRIPTION

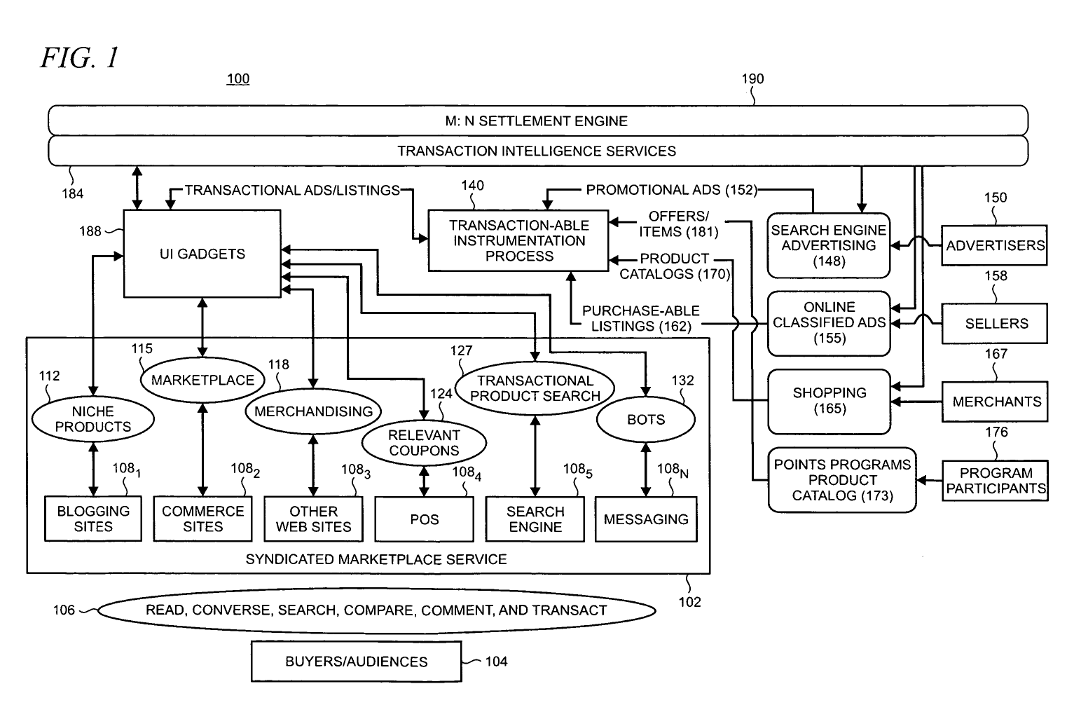

FIG. 1 is a diagram of an illustrative syndicated marketplace services model 100 which is used to highlight a primary goal of the present model of making a wide variety of products and services transaction-able in a virtual (i.e., online) marketplace. This capability enables buyers, or members of some target audience (collectively identified by reference numeral 104) to interact with the transaction-able products/services as indicated by reference numeral 106.

As shown in FIG. 1, a syndicated marketplace service 102 is directed to a variety of different types of platforms 108_{1, 2 . . . N} which include, respectively, blogging and other social networking web sites, commerce sites where certain products and services are typically offered on a commercial or retail basis, other web sites that are typically not focused on transactions of products and services, point-of-sale terminals such as those found at retail outlets (or transportation facilities like airports and rail stations), and Internet searching and messaging functionalities. It is emphasized that the platforms 108 shown in FIG. 1 are merely illustrative and that other platforms, alone or in combination with one or more of the platforms 108 shown in FIG. 1, may have transaction-able products and services facilitated through use of the present syndicated marketplace service model as may be required in a specific implementation.

The blogging site 108₁ typically relates to a particular topic, which in this example, is parenting. Accordingly, the addition of the present syndicated marketplace service enables niche products 112 (in this case baby-related items) to be readily marketed and sold to the blog readers by making them transaction-able as described herein. Such marketing may advantageously enable bloggers to monetize their insights and commentary that are provided in the blogs.

The commerce sites 108₂ may use the present syndicated marketplace service to either implement e-commerce on a standalone basis, or supplement the marketing channels and/or product and services offerings that they may already utilize. In this latter case, for example, additional breadth or depth to the site's product and service offerings may be realized by offering items from other marketplace sources 115 that are provided through the syndicated marketplace service 102. Such supplementation may often result in a perception of the buyer that a commerce site 108₂ is larger or provides more comprehensive offerings.

The other web sites 108₃ (i.e., those that are not typically associated with transaction-able products and services) may be enhanced by offering a merchandising component 118 enabled through the syndicated marketplace service 102. Such merchandising 118 is typically used to tie-in products and services that are related, for example, to the theme or content that is associated with a particular web site 108₃. The present syndicated marketplace service 102 may also reduce disruption of the user experience as well as minimize the potential for dilution of site's goodwill that may otherwise occur through redirection.

The syndicated marketplace service 102 is not necessarily limited to conventional e-commerce opportunities implemented through the web. For example, the existing functionalities provided by a POS terminal 108₄ may be supplemented through transaction-able products and services that are enabled by the present model. Thus, a coupon 124 or other type of redeemable instrument that is relevant to the transaction supported by the POS terminal 108₄ can be offered and the sale transacted through the syndicated marketplace service 102.

Other entry points to the syndicated marketplace service 102 may also be utilized. For example, web-based search engine 108₅ and instant messaging platform 108_{N} may be leveraged to enable interaction with transaction-able advertisements and listings. For example, when the users use a search service (such as Windows Live Search) and inputs “digital camera”, in addition to the conventional sponsor links where a redirect will be used, a syndicated marketplace UI gadget (as described in more detail below) will show all the digital cameras resulting from a transactional product search 127 which can then be transacted in-situ within the Live Search site. In this way, a camera merchant is provided with another way of reaching and acquiring their customers through a search engine without needing to have their own web sites.

In this illustrative example, the instant messaging platform 108_{N} is implemented using Windows Live Messenger (formerly known as MSN Messenger) which makes use of an existing “Bot” framework 132 to provide automated and interactive capabilities to messaging. Here, using a transaction bot (“Xbot”, accessed, for example, using the messaging address Xbot@PaymentLive.com), a Live Messenger user can explore details and then conclude a transaction using a familiar conversational messaging interface. For example, the messaging platform 108 may employ a points-based methodology, such as Microsoft Points or other type of non-cash transaction, or use a secure payment gateway, that enables the messaging user to converse with the Xbot in a messaging session to purchase products/services such as media content (e.g., games, music, etc). Such purchase could thus be performed without using a credit card and without needing to disclose personally identifying information.

As shown in FIG. 1, items from a variety of different sources are aggregated for syndication in a virtual marketplace through an instrumentation process represented by block 140 that makes the items transaction-able. These sources include a search engine advertising service 148 where advertisers 150 can place promotional advertisements 152 on search engines such as Microsoft Live Search. One example of such search engine advertising service is Microsoft adCenter, but the present arrangement is not limited to the adCenter service as other similar services provided by the major search engine providers may also be utilized.

Another source of transaction-able items is an online classified ad service 155, such as Windows Marketplace, where sellers 158 can list a variety of different kinds of purchasable merchandise and services 162, offer apartment rentals, promote local events, etc., in a similar manner as traditional classified advertising in newspapers. An online shopping service 165 provides another source of transaction-able items via product catalogs 170 from merchants 167 in the virtual marketplace. Points-type programs like Microsoft Points may also be sources of transaction-able offers and items 181 from point program participants 176 (e.g., entities that offer products and services that are redeemable with points instead of money). Points-type payment systems may also be utilized in scenarios where payments using traditional instrumentalities such as credits are impractical or expensive relative to the amount of money being transacted. In this case, the points system is referred to as a “micropayments” payment system.

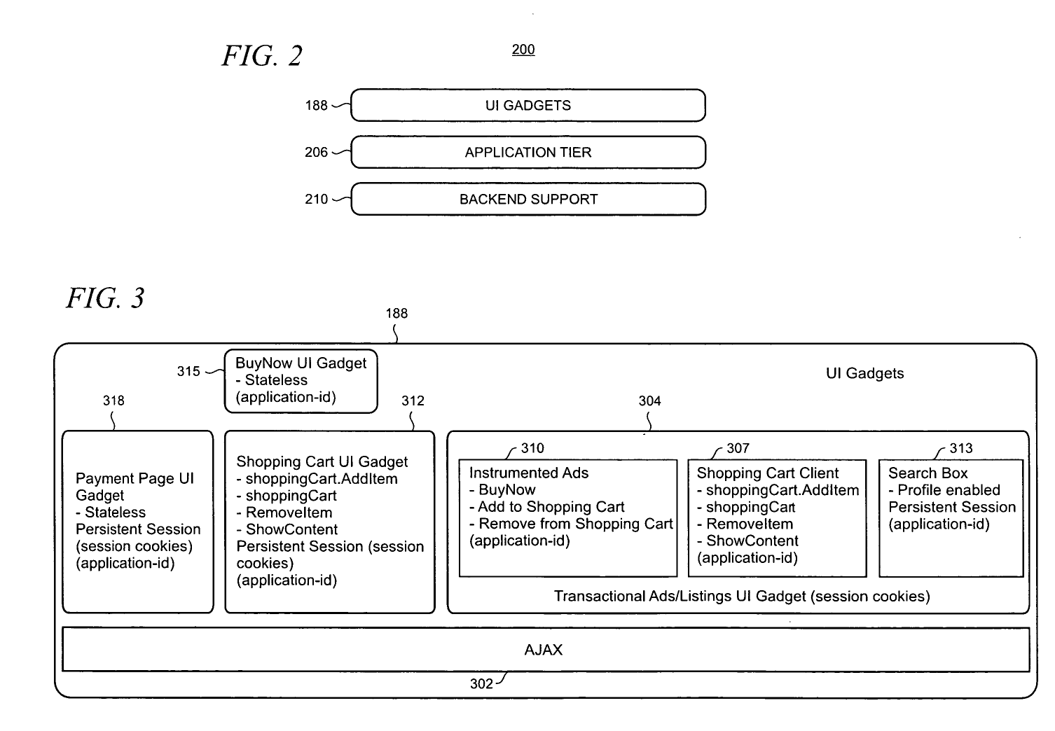

Transaction intelligence services 184 are included in the syndicated marketplace service model 100 to provide intelligence feeds to the UI gadgets 188 (which are described in more detail below in the description accompanying FIGS. 2 and 3), the search engine advertising service 148, online classified ad service 155, and online shopping service 165. Such intelligence feeds may comprise, for example, user buying patterns, purchase histories, and other data that describes user behavior, to help advertisers 150, sellers 158, and merchants 167 better tailor their marketing to the opportunities provided by the virtual marketplace. The transaction intelligence services 184 are also typically configured to provide real-time up-sell and cross-sell opportunities to the virtual marketplace sellers by monitoring what an end-user is putting into the shopping cart (via the shopping cart UI gadget described below). Monitoring such end-user activities can provide strong evidence of buyer intent, and thus may be usable for purposes of suggesting related products and services on an up-sell or cross-sell basis.

On top of the transaction intelligence services 184, is an M:N settlement engine 190. Settlement engine 190 is configured, in this illustrative example, to implement payout logic in a variety of syndicated marketplace service scenarios. The settlement engine 190, in particular, is configured to collect pay-ins from N parties and/or payment instruments (e.g., credit/debit cards, electronic payments, person-to-person (“P2P”), and the like) and perform payouts to M parties and and/or payment instruments.

FIG. 2 shows an illustrative tiered functional architecture 200 for the syndicated marketplace service 102 shown in FIG. 1. As shown, the functional architecture includes UI gadgets 188, an application tier 206, and backend support 210. Each is described in more detail, in turn, below.

FIG. 3 shows an illustrative implementation for the UI gadgets 188. The UI gadgets 188 are implemented, in this example, over the known AJAX programming framework 302, although other programming frameworks may also be used in alternative implementations. A transactional advertisement and listings UI gadget 304 implements a composite control where a shopping cart client 307, instrumented advertisements and listings 310, and a search box 313 are packaged together. Each of these components provides a number of invoke-able methods as shown. An application identifier (application-id) is also typically utilized to enable the methods to persist across a particular session.

The shopping cart client 307 provides the functionality for taking in advertisements and listings from the transactional advertisement and listing UI gadget 304 or any items from the Catalog UI gadget (which is shown in FIG. 5 and described in the accompanying text).

The instrumented advertisements and listings 310 comprise a list of items that are displayed as being purchase-able by the visitors to a web site that supports the present virtual marketplace. The list is typically arranged to be contextually related to the content, themes, or information supported by the web site. In addition, the site publisher may specify certain metadata to increase the relevance of the listing to the visitor. The instrumented advertisements and listings 310 are also provided with a functionality to be adjusted when an end-user adds an item to the shopping cart. This kind of intelligence is enabled by the transaction intelligence services 184 shown in FIG. 1 and described in the accompanying text. In addition, when the end-user clicks on the item, ratings of the merchants, reviews of the item, and any detailed description for the item may be displayed.

The search box 313 provides the end-user with the flexibility to query additional purchase-able items that are aggregated in syndicated item databases and exposable through the present syndicated marketplace service 102 (FIG. 1). The items in the listing resulting from the end-user query may also be added to the shopping cart to enable a consistent buying experience without having to leave the site.

A shopping cart UI gadget 312 is configured as a standalone UI gadget, as compared with the shopping cart client 307 that is part of the composite control functionality provided by the transactional advertisement and listing UI gadget 304. The function of the shopping cart UI gadget is to enable all the instrumented items from either the catalog UI gadget or transactional advertisement and listing UI gadget 304 to be added to the same shopping cart. The other behaviors and functionalities provided by the shopping cart UI gadget 312 are similar to those provided by the transactional advertisement and listing UI gadget 304.

A buy-now UI gadget 315 is also supported in this example. This UI gadget enables an instrumented item to be pushed to a payment page for checkout. A payment page UI gadget 318 may be added to the checkout process of a typical e-commerce site to enable a transaction to be performed. With the payment page UI gadget 318, conventional payment instruments such as credit/debit cards are supported. In addition, P2P and point-type systems (e.g., Microsoft Points) may also be supported. In alternative implementations, instead of using a payment gadget that runs on the payment page of a site, a centralized payment page may be provided for a multiplicity of publishers that utilize the present syndicated marketplace service 102 (FIG. 1).

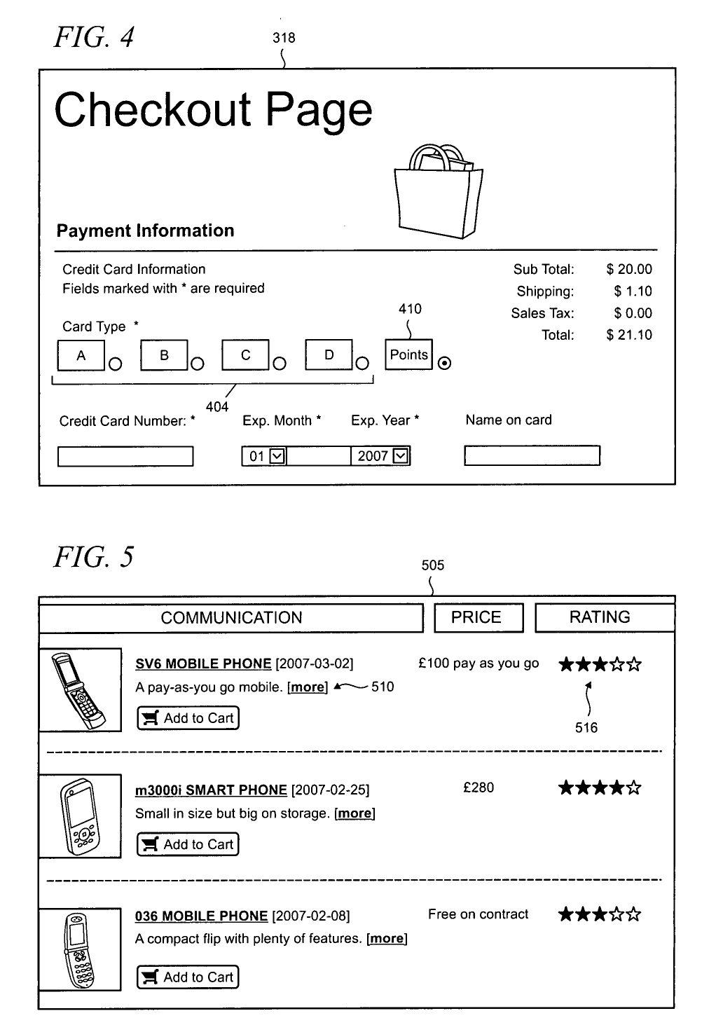

An illustrative payment page UI gadget 318 is shown in FIG. 4. In this example, the payment page UI gadget 318 implements a checkout process that provides support for several alternative credit cards A, B, C and D (collectively indicated by reference numeral 404 in FIG. 4). Also provided is a choice for the end-user to use a points-type payment program in lieu of a credit card payment, as indicated by reference numeral 410.

When the publisher is also a merchant, the publisher may wish to upload a product catalog to the syndicated marketplace service 102 so the items in the product catalog are instrumented to work in the virtual marketplace. After the instrumentation process 140, the merchant will get a catalog UI gadget to cut-and-paste into his web site. FIG. 5 shows a typical example of a catalog gadget UI 505. The behavior of the products/services listing exposed by the catalog UI gadget 505 will typically be similar to the behavior facilitated by the transactional advertisement and listing UI gadget 304 as discussed above in the description accompanying FIG. 3. Another example is for the merchant to request other third party sites to host this UI gadget so as to increase the reach for listed products and services. When this is done, the third party thus acts as a publisher which may be desirable in some implementations of syndicated marketplace services.

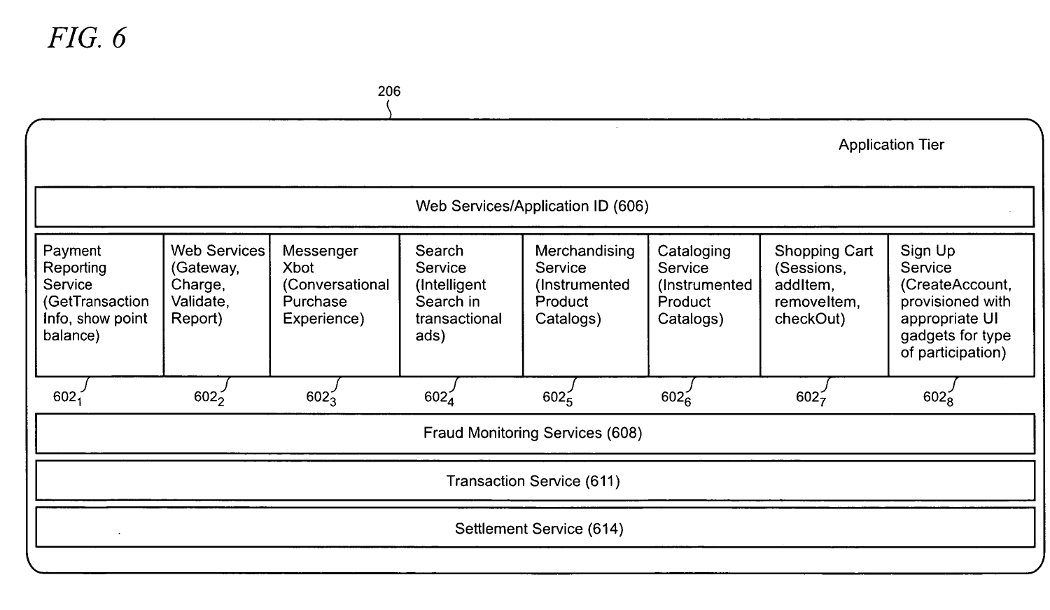

FIG. 6 shows an illustrative implementation for the application tier 206. The application tier 206 provides a set of core services 602 for the syndicated marketplace services. The payment reporting core service 602₁ enables a payment gateway to be utilized in the syndicated marketplaces service 102 (FIG. 1). Typically, credit/debit card payments, point-based payment systems, P2P and combinations thereof can be supported by this core service. In addition, the payment reporting core service 602₁ will integrate with the shopping cart to get the required transaction line items and identify the purchased items to the appropriate payment gateway. The payment reporting core service 602₁ may also optionally be used to include additional instrumented transactional advertisements and listings to encourage up-sell and cross-sell opportunities, as discussed above. As shown, the payment reporting core service 602₁ will implement methods such as getting transaction information and showing point balances (in point-based systems).

Web services 602₂ are implemented to deal typically with business-to-business communications attendant to the provisioning of the syndicated marketplace service 102 at a particular site. Web services 602₂ thus implement methods relating to a payment gateway and charges, as well as data validation and reporting. For example, web services 602₂ enable publishers and merchants to see basic aggregated transaction reports from the payment reporting core service 602₁. Such reports may include the total transaction amount, breakdowns of line-items, taxes, pay-out amounts, and the like. Reports can also provide sales data by month, by product, by customer, etc. In addition to the basic reports, advanced reporting may also be supported to enable analysis of transaction data or importation of the data to financial reporting applications.

The Messenger Xbot core service 602₃ is used to implement the conversational bot-based purchase experience described above in the text accompanying FIG. 1.

The search core service 602₄ enables interactions between the buyers and the instrumented transactional advertisements and listings. This service behaves to give buyers the ability to query any specific products or services by name. Advanced or “intelligent” search functionality such as search by manufacture, by merchant, or by other metadata may also be provided in some settings to enhance the usability of the search. Typically, the core search service 602₄ is arranged to be leveraged from existing search engine functionalities when possible. Thus, the search core service 602₄ may be embodied as a specific instance of a search service, such as the MSN search service.

The merchandising core service 602₅ is configured to help end-users make informed purchase decisions when buying items in the virtual marketplace. The merchandising core service 602₅ may be applied to instrumented product catalogs, for example, to provide additional details about a particular product, ratings (or feedback from other buyers) about the product or merchant, and other similar purchase-assistive information. Such informed purchase information is shown in the UI catalog gadget 505 in FIG. 5, as indicated by reference numerals 510 (more information) and 516 (ratings).

Referring again to FIG. 6, the cataloging core service 602₆ interoperates with the catalog UI gadgets (e.g., catalog UI gadget 505 in FIG. 5) where it retrieves metadata information from the syndicated items databases to instrument those items to be served by the UI gadgets 188 so they are transaction-able. The instrumentation process (also indicated by reference numeral 140 in FIG. 1) enabled by the cataloging core service 602₆ ensures that these items will be put in the shopping cart when clicked. In addition, the instrumentation process enables a set of web pages associated with the syndicated marketplace service 102 to offer a self-serving type of uploading for a merchant's product catalog so the items can be sold in the virtual marketplace.

The shopping cart core service 602₇ enables a session-based shopping experience. For example, the items that are added to the shopping cart should persist across pages within a session. The shopping experience may optionally be persisted using client site cookies so the items in the cart will persist across sessions. The shopping cart core service 602₇ is further arranged to interface with the transaction intelligence services 184 (FIG. 1) to react to items being added to the shopping cart and to responsively expose additional functionalities such as up-sell and cross-selling opportunities, as described above, to help guide end-users in making additional purchases of related items. In addition, the shopping cart core service 602₇ provides basic methods including, for example, addItem (from cart), removeItem (from cart), and checkOut (including, for example, totaling, and quantity revision functionalities).

The sign up core service 602₈ is supported to enable persons to sign up as a participant with the present syndicated marketplace service 102. Various participant types are supported—publishers, merchant sellers, advertisers, and casual sellers. At the conclusion of the sign-up process, the participant is provisioned with a set of UI gadgets based on the syndicated marketplace service participant type.

Publishers are persons or businesses that sign up for the syndicated marketplace service 102 for the web sites they own or operate. They do not have physical goods or services to sell themselves, but they have desirable content on the web sites and want to monetize it by supporting transactions. Typical publishers include bloggers, personal spaces owners, etc.

Merchant sellers are typically businesses that want to sell their own products and services online. Casual sellers may also be businesses, although most will typically be persons that want to sell products and services online in a virtual marketplace.

Advertisers are persons or businesses that sign up for search engine advertising services 148 (FIG. 1), such as adCenter advertising services. The syndicated marketplace services 102 will enable the adCenter advertisers to have an option to buy advertisements using the CPA cost model in which they will only pay if transactions or customer acquisitions take place. In addition, the advertisers will also be able to choose a specific set of web sites to help sell their products and services to reach the right audiences.

As shown in FIG. 6, the core services 602 reside in between layers in the application tier 206 that represent other functionalities that are implemented to support the marketplace services 102. These functionalities include, web Services/application ID 606, fraud monitoring services 608, transaction services 611, and settlement services 614.

The web services/application ID 606 is typically used to report transactions and associate payouts to appropriate authenticated parties. The fraud monitoring services 608 are typically arranged as a suite of services that proactively look at all the commerce transaction activities associated with the virtual marketplace to help prevent any fraudulent activities or abuses. The fraud monitoring services 608 concentrates on spotting three common types of online fraud activity: product theft, identity fraud and cash fraud. Product theft refers to the use of stolen credit card information to make unauthorized product purchases. Identity fraud refers to the theft of an individual's personal information, including financial information, from online transaction systems. Cash fraud refers to the use of online transaction systems to issue unauthorized refunds to a credit card. In many implementations, the fraud monitoring services 608 are provided free to all the merchants and publishers participating in the syndicated marketplace service 102 so that they are protected from potential fraudulent purchases.

The transaction service 611 and settlement service 614 operate together to implement the M:N settlement engine 190 shown in FIG. 1 and described in the accompanying text. As noted above, the settlement engine 190 is typically configured to perform transaction settlement services using traditional payment instruments, as well supporting P2P scenarios.

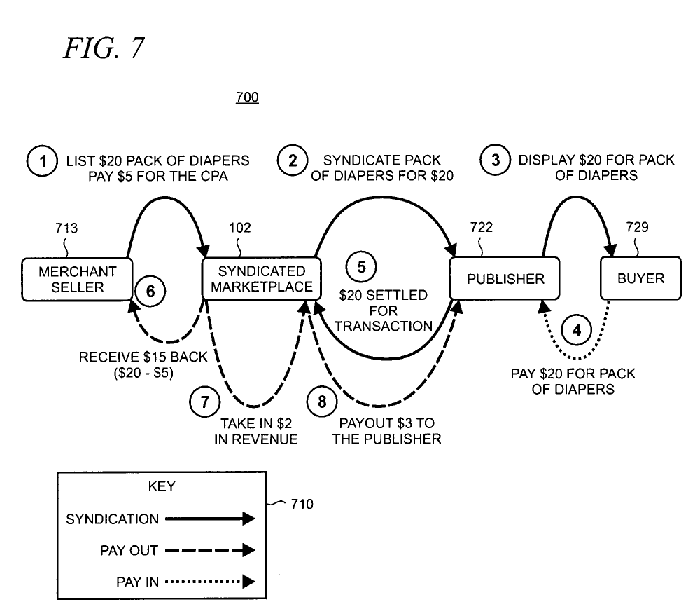

FIG. 7 shows an illustrative syndication and settlement flow 700 that may be implemented by the settlement engine 190 (FIG. 1). As shown in the key 710, the solid lines indicate syndication process flow; the lines with large dashes indicate pay-outs, and; the line with small dashes indicates pay-ins. At step 1 in the illustrative settlement flow, a merchant seller 713 places a transaction-able instrumented advertisement or listing for a pack of diapers using the syndicated marketplace service 102 (FIG. 1). Using the CPA cost model, the merchant seller 713 will pay a transaction fee only when the pack of diapers is sold in a completed transaction via the syndicated marketplace service 102.

At step 2, a web site publisher 722 (e.g., a blogger commenting on parenting issues) takes the transactional advertisement or listing and displays the pack of diapers for a $20 sale price on the publisher's sites to a potential buyer 729 (e.g., a parenting blog subscriber) at step 3. At step 4, the buyer 729 completes the purchase on the parenting blogging site, for example, by using a payment UI gadget (e.g., payment UI gadget 318 shown in FIGS. 3 and 4).

At step 5, the publisher 722 remits the $20 to the syndicated marketplace service 102 as settlement for the diaper pack transaction with the buyer 729. The syndicated marketplace service 102 takes the $5 CPA transaction fee and the merchant seller receives $15 back at step 6. Of that $5, the syndicated marketplace service 102 takes $2 as revenue at step 7, and pays out $3 to the publisher 722 at step 8. It is emphasized that dollar amounts used in the illustrative syndication and settlement flow 700 are provided as examples and that the CPA transaction fee, pay-ins, and pay-outs used in any particular syndicated marketplace service scenario can be expected to vary from those amounts shown in FIG. 7.

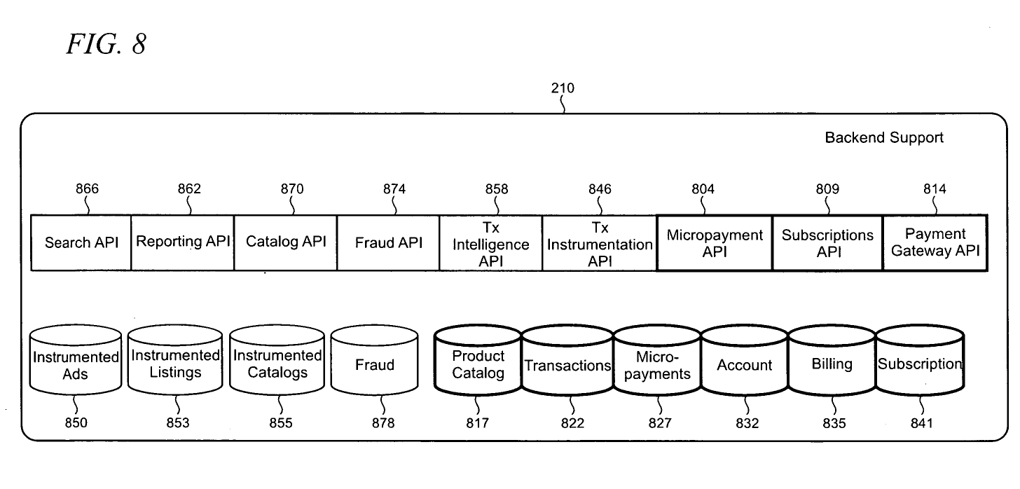

FIG. 8 shows an illustrative implementation for the backend 210 (FIG. 2) that supports the provisioning of the syndicated marketplace services 102 (FIG. 1). In this illustrative example, the backend support 210 uses a number of components that supplement the functionality of existing known components. These existing components, which are indicated by the heavy lines in FIG. 8, include a micropayments API 804, subscription API 809, and payment gateway API 814. These APIs respectively enable interaction with the various existing databases, as shown, that are used to implement conventional online transactions using point-type payments, subscription-based transactions, and standard e-commerce payments using credit/debit cards and the like. The existing databases include a product catalog 817, transaction database 822, micropayments database 827, account database 832, billing database 835, and subscription database 841.

Supplemental functionalities are provided by several APIs and databases that are used, in this illustrative example, to implement the present syndicated marketplace service 102 (FIG. 1). The supplemental APIs include a transactional instrumentation API 846 to provide instrumentation to transactional advertisements, listings, and catalogs, as described above in the text accompanying FIG. 6. Instrumented transactional advertisements, listings and catalogs (and associated metadata) are stored in respective syndicated item databases 850, 853 and 855 which may be accessed and searched in association with the syndicated marketplaces service 102. A related transactional intelligence API 858 is further utilized to analyze the end-users' purchase behavior and patterns that may support the provisioning of the transaction intelligence services 184, shown in FIG. 1 and described in the accompanying text, which can assist in targeting a seller's marketing to the circumstances of a particular scenario. A catalog API 870 is used to interact with stored metadata in the syndicated items databases 850, 853 and 855 as required to perform the instrumentation process described above in the text accompanying FIG. 6.

A search API 866 exposes the required functionality needed to search stored instrumented transactional items in the syndicated databases 850, 853, and 855. Conventional indexing engines and query processes may be utilized in most settings. Similarly, a reporting API 862 exposes reporting functionalities as required to implement the reporting features provided by the core web service 602₂ (FIG. 6).

A fraud API 874 and associated fraud database 878 are also implemented in the backend 210 to provide anti-fraud infrastructure. While such infrastructure can be expected to provide safeguards to all transactions in the virtual marketplace, the P2P-type payments are particularly targeted in order to enhance the ability to readily complete transactions using such a payment instrument.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for implementing a syndicated marketplace service, the method comprising the steps of:
providing instrumentation to an item for sale, the instrumentation enabling the item to be transaction-able in a syndicated marketplace;
binding the instrumented item to one or more UI gadgets, the one or more UI gadgets exposing pre-defined functionality on an information resource to end-users to enable interaction with the instrumented item; and
completing a purchase transaction for the instrumented item on the information resource responsively to end-user interaction with the one or more UI gadgets.

2. The method of claim 1 in which the information resource is provided by one of web site, blogging web site, e-commerce web site, POS terminal, search engine, or messaging platform.

3. The method of claim 2 in which the implementing of the syndicated marketplace service provides an end-user experience that enables an end-to-end purchase transaction to take place in-situ on the web site without having to redirect the end-user to a different web site.

4. The method of claim 1 including a further step of applying settlement logic to distribute proceeds from the transaction and assess a fee associated with the transaction.

5. The method of claim 4 in which the settlement logic is implemented in a settlement engine configured to collect pay-ins from N parties or payment instruments, and perform pay-outs to M parties or payment instruments.

6. The method of claim 4 in which the settlement logic uses a cost-per-action cost model to set the fee.

7. The method of claim 1 in which the item is sourced from one of search engine advertising service, online classified advertising service, online shopping catalog, catalog associated with a points-type item redemption system, or a merchant catalog.

8. The method of claim 1 in which the instrumentation binds transaction behavior to the item, the transaction behavior exposing purchase options for the item when selected by the end-users.

9. A method for providing a user interface to a syndicated market transaction, the method comprising the steps of:
receiving data associated with syndicated items, the syndicated items drawn from a plurality of sources and being saleable at a virtual marketplace;
providing the user interface, the user interface configured for i) selectively exposing the received data as a functionality displayable on a publishing web site and, ii) enabling completion of the transaction on the publishing web site through the functionality; and
receiving input from an end-user to the user interface responsively to the selectively exposed data.

10. The method of claim 9 in which the received data comprises one of transactional advertisement or transactional listing.

11. The method of claim 9 in which the user interface is embodied in a UI gadget that is operable using one or more AJAX programming methods.

12. The method of claim 11 in which the UI gadget is a UI shopping cart gadget that is arranged for providing a virtual shopping cart to hold an end-user purchase selection of one or more of the syndicated items from a syndicated catalog gadget, or from transaction-able items shown by the publishing web site.

13. The method of claim 11 in which the UI gadget is a payment page UI gadget that is arranged for providing payment options to the end-user for one or more of the syndicated items.

14. The method of claim 11 in which the UI gadget is a search UI gadget that is arranged for enabling an end-user search of the syndicated items.

15. The method of claim 9 in which the selective exposing is contextual, a context being based on one of theme, content, or information provided by the web site.

16. The method of claim 9 in which the selective exposing uses transaction intelligence comprising one of buying pattern, purchase history, or data that describes end-user behavior.

17. The method of claim 12 in which the selective exposing uses content of the virtual shopping cart to expose one of up-sell item or cross-sell item.

18. The method of claim 11 including a further step of providing purchase guidance to the end-user through the UI gadget, the purchase guidance selected from one of user feedback, user rating of an instrumented item, user rating of a merchant, or descriptive information associated with the instrumented item.

19. A method for applying a cost model to a sale of a product or service, the method comprising the steps of:
providing a syndicated marketplace service to a seller, the syndicated marketplace service enabling the product or service to be syndicated for sale at a virtual marketplace; and
collecting a transaction fee from the seller using a cost-per-action cost model that imposes the transaction fee on the seller upon completion of a sale transaction for the product or service on the virtual marketplace.

20. The method of claim 19 in which the enabling comprises applying instrumentation to an advertisement or a listing for the product or service, the instrumentation being arranged for exposing methods for completing the transaction when the advertisement or listing is selected by a buyer at the virtual marketplace.
